(19) United States
(12) Patent Application Publication
(10) Pub. No.: US 2010/0017571 A1
(43) Pub. Date: Jan. 21, 2010

(54) CONTENT WRITE-IN DEVICE

(76) Inventors: Hiroshi Nakaji, Tokyo (JP); Shigeru Kawabe, Tokyo (JP); Dalsuke Yamazaki, Tokyo (JP); Kazuhito Takai, Tokyo (JP)

Correspondence Address: Mr. Jackson Chen, 6535 N. STATE HWY 161, IRVING, TX, 75039, US

(21) Appl. No.: 12/443,005

(22) PCT Filed: Sep. 27, 2007
(86) PCT No.: PCT/JP2007/068771

§ 371 Date: Mar. 26, 2009

(30) Foreign Application Priority Data
Sep. 28, 2006 (JP) 2006-265399

(51) Int. Cl. G06F 12/00

(52) U.S. Cl. 711/155; 711/E12.001

(57) ABSTRACT

It is possible to classify a continuous content into separate series to be written into a storage medium. A reception device receives a digital broadcast program and EIT and generates program attribute information according to the information associated with the series contained in EIT. Upon reception of a write-into-DVD instruction of a recorded digital broadcast program in a program recording region inputted by a user via UI, a write control device integrates the program attribute information in the program attribute information storage region, the write-into-DVD history information in the write-into-DVD history information storage region, and the DVD information obtained from the DVD drive, so as to judge whether write into DVD is enabled. The write control device presents the judgment information to the user via UI and controls write of the recorded digital broadcast program into the DVD according to the user instruction input information acquired via the UI.

### APPLICABLE FIELD IN THE INDUSTRY

The present invention relates to a device for enabling a continuous content of an identical series to be written into a storage medium in a lump by classifying a content into separate series.

### BACKGROUND ART

In recent years, it has become possible to record/preserve a larger number of programs as compared with the past owing to a spread of an HDD recorder. On the other hand, various techniques for alleviating a user's labor and time have been proposed because the work for pigeonholing recorded and saved program contents requires pains. For example, in Patent document 1, the technology is disclosed for enabling recording conditions and dubbing conditions from a hard disc to a removable storage medium to be set by collecting the continuous programs being broadcast in the same time band every predetermined period with the same title and channel.

[Patent document 1] JP-P2005-347822A

### DISCLOSURE OF THE INVENTION

### Problems to be Solved by the Invention

However, while the continuous content of an identical series can be written into an identical storage medium in a lump in the technology described in the Patent document 1, there exist a problem that the content classified into separate series cannot be written into the storage medium when the continuous content of an identical series is successively written into the storage medium because it cannot be confirmed whether the continuous content of an identical series was previously written into a write-destination storage medium.

Thereupon, the present invention has an object of providing a device for enabling the continuous content classified into separated series to be written into a storage medium by, at the moment of writing the content into a storage medium, confirming the content previously written into the above storage medium and notifying a confirmation result to a user.

### Means for Solving the Problem

The present invention for solving the above-mentioned problems, which is a write-in device, is characterized in including: an investigating means for investigating whether a first content already written into a storage medium and a second content that is going to be written into this storage medium belong to an identical series based upon information associated with each content; and a writing-in means for writing the second content into the storage medium when as a result of the investigation, they belong to an identical series.

The present invention for solving the above-mentioned problems, which is a write-in method, is characterized in including: an investigating step of investigating whether a first content already written into a storage medium and a second content that is going to be written into this storage medium belong to an identical series based upon information associated with each content; and a second content writing-in step of writing the second content into the storage medium when as a result of the investigation, they belong to an identical series.

The present invention for solving the above-mentioned problems, which is a program for an information processing device, is characterized in that the program causes the information processing device to execute: an investigating step of investigating whether a first content already written into a storage medium and a second content that is going to be written into this storage medium belong to an identical series based upon information associated with each content; and a second content writing-in step of writing the second content into the storage medium when as a result of the investigation, they belong to an identical series.

A content write-in device of the present invention is characterized in that: the content write-in device includes: a writing-in means for writing a first content into a storage medium; a first storing means for storing identification information of the first content and identification information of the storage medium correspondingly to each other; a second storing means for storing a second content; a third storing means for, when the second storing means has stored the second content, storing identification information of the above second content; and a comparing means for comparing the identification information of the first content stored by the first storing means and the identification information of the second content stored by the third storing means; and when as a result of comparing the identification information of the first content and the identification information of the second content by the above comparing means, it has been determined that they are identical, the writing-in means writes the second content into the storage medium.

Further, the content write-in device of the present invention may be adapted to include a notifying means for notifying a comparison result to a user when as a result of comparing the identification information of the first content and the identification information of the second content by the above comparing means, it has been determined that they are not identical.

Further, the content write-in device of the present invention may be adapted to include a receiving means for receiving the first content and the second content.

Further, the content write-in device of the present invention may be adapted so that the receiving means receives the identification information of the first content and the identification information of the second content.

Further, the content write-in device of the present invention may be adapted so that the receiving means generates the identification information of the first content and the identification information of the second content.

Further, the content write-in device of the present invention may be adapted so that when the writing-in means has written the second content into the storage medium, the first storing means stores the identification information of the second content and the identification information of the storage medium correspondingly to each other.

### An Advantageous Effect of the Invention

In accordance with the present invention, at the moment of writing a content into a storage medium, by confirming whether the content previously written into the above storage medium is a content of a series identical to that of the content that is going to be written, and notifying a confirmation result to a user, the continuous content of an identical series can be successively written into the identical storage medium, and the continuous content classified into separate series can be written into the identical storage medium.

### BRIEF DESCRIPTION OF THE DRAWINGS

FIG. 1 is a view illustrating information associated with a series that is contained in an EIT of a digital broadcast program.

FIG. 2 is a block diagram illustrating a first embodiment of the content write-in device in accordance with the present invention.

FIG. 3 is a view illustrating program attribute information that is generated by a reception device 3 shown in FIG. 2 in the first embodiment.

FIG. 4 is a view illustrating write-into-DVD history information associated with a DVD written by a content write-in device 1 shown in FIG. 2.

FIG. 5 is a flowchart illustrating a process of writing a recorded digital broadcast program into the DVD.

FIG. 6 shows a specific example of a request 1 that UI 8 shown in FIG. 5 displays.

FIG. 7 shows a specific example of a request 2 that the UI 8 shown in FIG. 5 displays.

FIG. 8 shows a specific example of a request 3 that the UI 8 shown in FIG. 5 displays.

FIG. 9 shows a specific example of a request 4 that the UI 8 shown in FIG. 5 displays.

FIG. 10 is a flowchart for explaining in details an investigating process being performed by a write-in control device 7 in step S5 of FIG. 5.

FIG. 11 shows a specific example of a warning 1 that the UI 8 shown in FIG. 10 displays.

FIG. 12 is a flowchart for explaining in details an investigating process being performed by a write-in control device 7 in step S6 of FIG. 5.

FIG. 13 shows a specific example of a warning 2 that the UI 8 shown in FIG. 12 displays.

FIG. 14 is a view illustrating program attribute information that is generated by the reception device 3 shown in FIG. 2 in a second embodiment.

FIG. 15 is a view illustrating write-in history information that is generated in a write-in history information storage region 6 shown in FIG. 2 in the second embodiment.

### DESCRIPTION OF NUMERALS

1 content write-in device

2 antenna

3 reception device

4 program recording region

5 program attribute information storage region

6 write-into-DVD history information storage region

7 write-in control device

8 UI

9 DVD drive

### BEST MODE FOR CARRYING OUT THE INVENTION

Hereinafter, the embodiments of the present invention will be explained by making a reference to accompanied drawings.

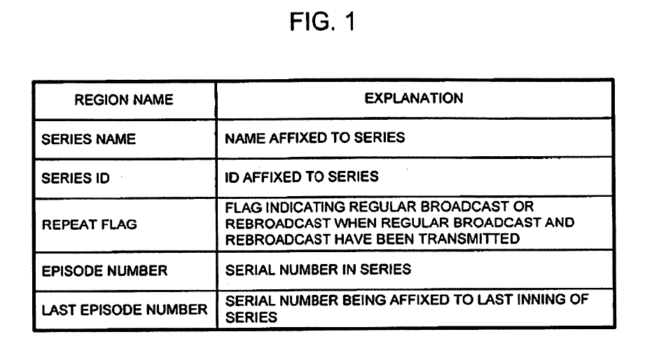

The first embodiment premises that information associated with a series shown in FIG. 1 is contained in an EIT (Event Information Table) of the digital broadcast program. Further, it is assumed that a DVD (storage medium) into which the digital broadcast programs have already been recorded has DVD identification information for uniquely identifying the above DVD affixed hereto. Additionally, with regard to the so-called series, the contents caused to correspond to each other according to a predetermined definition such as a text and a broadcast time band, for example, the contents including a full story in the case of a drama, are called an identical series.

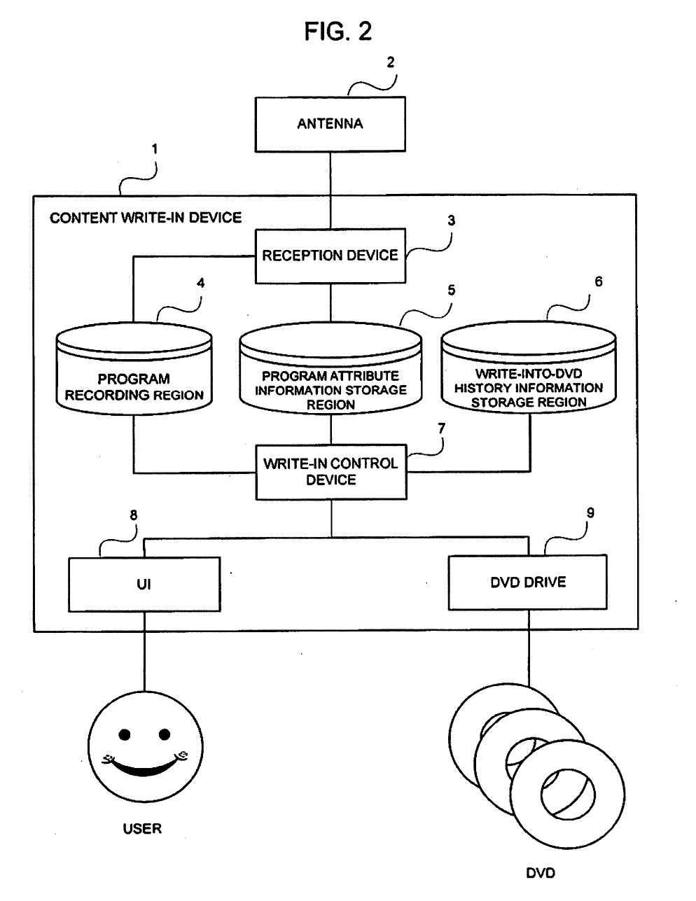

FIG. 2 is a block diagram illustrating the first embodiment. A content write-in device 1, which is connected to an antenna 2, is comprised of a reception device 3, a program recording region 4, a program attribute information storage region 5, a write-into-DVD history information storage region 6, a write-in control device 7, a UI 8, and a DVD drive 9.

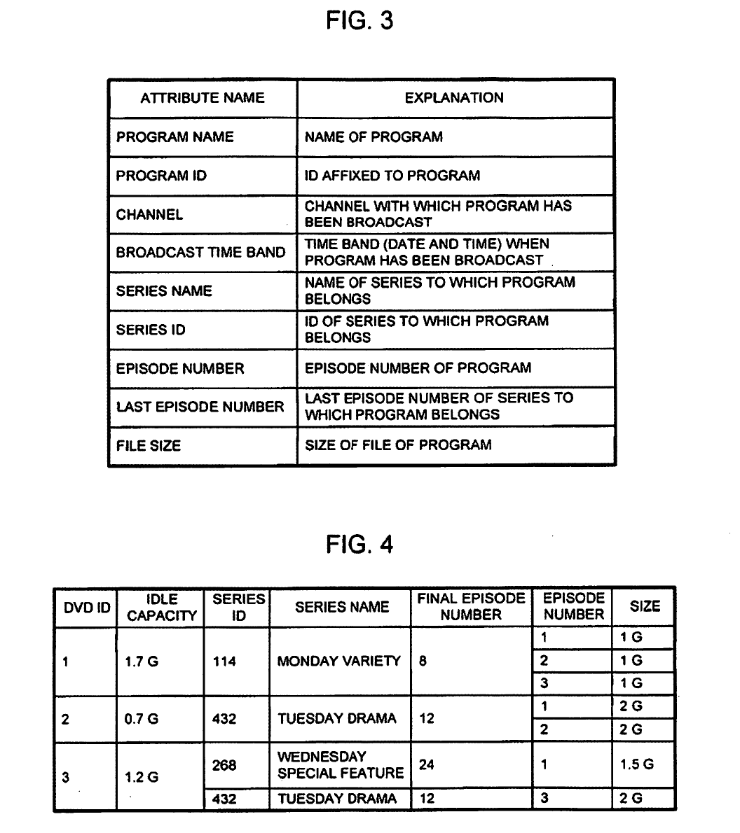

The reception device 3 is a device for receiving the digital broadcast program and the EIT through the antenna 2, and generating program attribute information based upon information associated with the series being contained in the EIT. The program attribute information being generated herein is one shown in FIG. 3.

The program recording region 4 is a region in which the digital broadcast program received by the reception device 3 is recorded. Broadcast program identification information for uniquely identifying the digital broadcast program is affixed to each digital broadcast program.

The program attribute information storage region 5 is a region in which the program attribute information generated by the reception device 3 is stored. Broadcast program identification information for uniquely identifying the program attribute information of the received digital broadcast program is affixed to the program attribute information, and corresponds to the broadcast program identification information being affixed to the digital broadcast program.

The write-into-DVD history information storage region 6 is a region in which write-into-DVD history information associated with the DVD ever recorded by the content write-in device 1 is stored. The write-into-DVD history information being stored herein is one shown in FIG. 4.

The write-in control device 7 is an arithmetic unit for controlling the write of the recorded digital broadcast program within the program recording region 4 into the DVD. After the write-in control device 7 integrates the program attribute information within the program attribute information storage region 5, the write-into-DVD history information within the write-into-DVD history information storage region 6, and DVD information (DVD ID) being obtained from the DVD drive 9, thereby to determine whether the write into the DVD is enabled, and presents determination information thereof to a user via the UI 8, it controls the write of the recorded digital broadcast program into the DVD based upon user's instruction input information that is acquired via the UI 8.

The UI 8 is a device for enabling an information presentation to the user and an instruction input by the user.

The DVD drive 9 is a device for loading the DVD information, and writing the recorded digital broadcast program into the DVD.

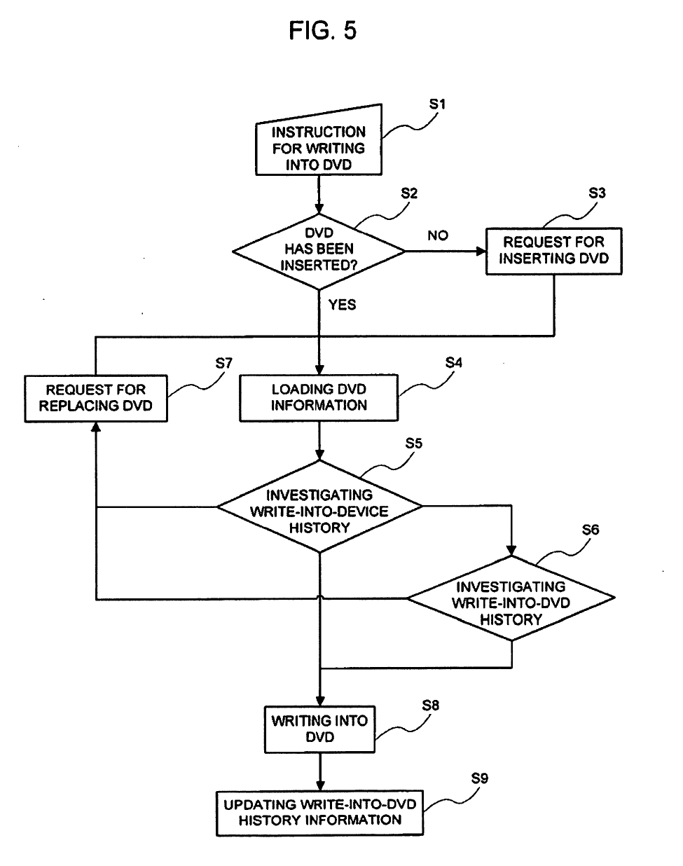

FIG. 5 is a flowchart illustrating a process of writing the recorded digital broadcast program into the DVD.

The UI 8, upon receipt of an instruction for writing the recorded digital broadcast program into the DVD by the user, transfers instruction input information including the broadcast program identification information of the digital broadcast program being written into the DVD to the write-in control device 7 (step S1).

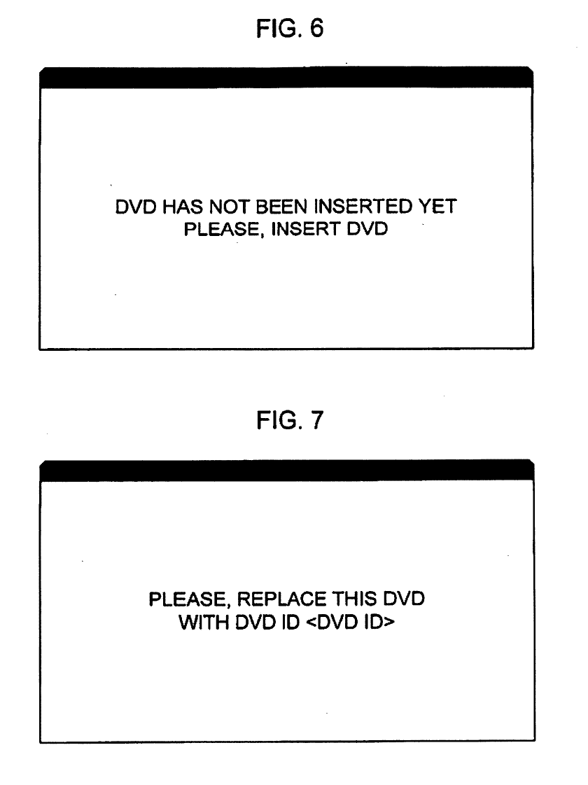

The write-in control device 7 having acquired the user's instruction input information via the UI 8 confirms whether the DVD has been inserted into the DVD drive 9 (step S2). The write-in control device 7, when the DVD has not been inserted, causes the UI 8 to display a request 1 as exemplified in FIG. 6, thereby to urge the user to insert the DVD (step S3). And, when the user has inserted the DVD, the process of step S4 and steps after it is executed.

When it has been confirmed in the step S2 that the DVD has been inserted, the DVD drive 9 loads DVD information of the inserted DVD, and transfers it to the write-in control device 7 (step S4).

The write-in control device 7, based upon the broadcast program identification information of the user's instruction input information acquired via the UI 8 in the step S1, acquires program attribute information of the recorded digital broadcast program for which the write into the DVD has been instructed from the program attribute information storage region 5, and therewith, acquires the write-into-DVD history information from the write-into-DVD history information storage region 6. And, the write-in control device 7 collates the acquired program attribute information and write-into-DVD history information, and the DVD information transferred in the step S4 with each other, and investigates whether other recorded digital broadcast programs having a series ID identical to that of the acquired program attribute information have been written into the DVD in the past, whether a sufficient idle capacity for writing this-time recorded digital broadcast program exists in the above DVD if it has been ever written, whether the above DVD coincides with the DVD currently inserted into the DVD drive 9 if an idle capacity exists, and whether the write of the recorded digital broadcast program into the inserted DVD is in keeping with a user's intention if it does not coincide (step S5).

When the write-in control device 7 has determined to investigate the DVD inserted into the DVD drive 9 as a result of the investigation in the step S5, it investigates whether a sufficient idle capacity for writing this-time recorded digital broadcast program exists in the DVD, whether the recorded digital broadcast programs having a series ID different from that of this-time recorded digital broadcast program has been ever written into the DVD if an idle capacity exists, and whether the write of the recorded digital broadcast program into the DVD is in keeping with a user's intention if it has been ever written (step S6).

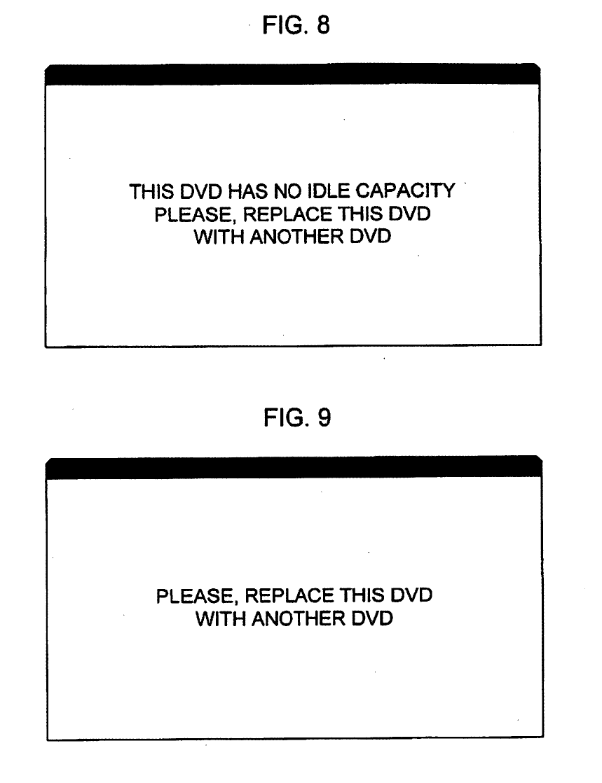

When the write-in control device 7 has determined to replace the DVD inserted into the DVD drive 9 as a result of the investigation in the step S5 or the step S6, it causes the UI 8 to display a request 2 as exemplified in FIG. 7, a request 3 as exemplified in FIG. 8, or a request 4 as exemplified in FIG. 9 as an investigation result, thereby to urge the user to replace the DVD (step S7). And, when the user has replaced the DVD, the process of the step S4 and steps after it is executed.

When as a result of the investigation in the step S5 or the step S6, the write-in control device 7 has determined to write the recorded digital broadcast program into the DVD inserted into the DVD drive 9, the DVD drive 9, according to an instruction by the write-in control device 7, writes the recorded digital broadcast program into the DVD (step S8). When the recorded digital broadcast program has been written into the DVD in the step S8, the write-in control device 7 updates the write-into-DVD history information stored in the write-into-DVD history information storage region 6 (step S9). When the recorded digital broadcast program has been written into a new DVD, the write-in control device 7 affixes DVD identification information to the new DVD, and employs the above DVD identification information, thereby to record the write-into-DVD history information in the write-into-DVD history information storage region 6.

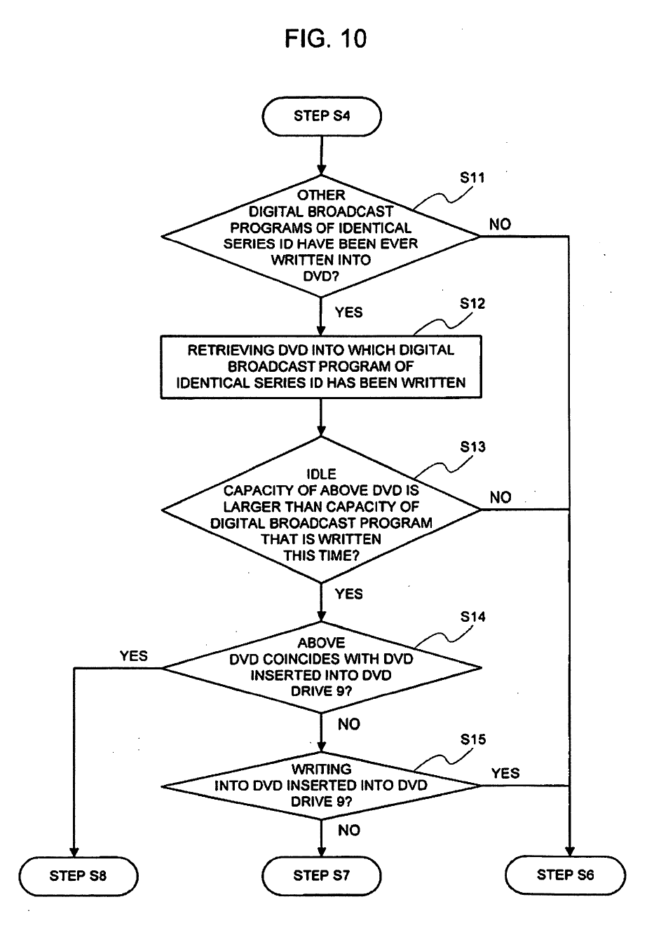

Next, the investigating process by the write-in control device 7 in the step S5 of FIG. 5 will be explained in details by making a reference to a flowchart of FIG. 10.

At first, the write-in control device 7 collates the acquired program attribute information and write-into-DVD history information with each other, and investigates whether the other recorded digital broadcast programs having a series ID identical to that of the acquired program attribute information have been written into the DVD in the past (step S11). If it has not been written, the process of the step S6 and steps after it in FIG. 5 is executed.

If the other recorded digital broadcast programs have been ever written, the write-in control device 7 retrieves the DVD, into which the recorded digital broadcast program having a maximum episode number, out of the numbers smaller than the episode number of the acquired program attribute information, has been written, from among the DVDs into which the other recorded digital broadcast programs having a series ID identical to that of the acquired program attribute information have been written in the past (when the number of the DVDs into which the other recorded digital broadcast programs having a series ID identical to that of the acquired program attribute information have been written in the past is only one, the very DVD) (step S12), and investigates which, out of the idle capacity of the above DVD and the capacity of the recorded digital broadcast program that is going to be written this time, is larger (step S13). When the capacity of the recorded digital broadcast program that is going to be written this time is larger than the idle capacity of the above DVD, the process of the step S6 and steps after it in FIG. 5 is executed.

When the capacity of the recorded digital broadcast program that is going to be written this time is smaller than the idle capacity of the above DVD, or their capacities coincide with each other, the write-in control device 7 investigates whether the above DVD coincides with the DVD currently inserted into the DVD drive 9 (step S14). When they coincide, the process of the step S8 and steps after it in FIG. 5 is executed.

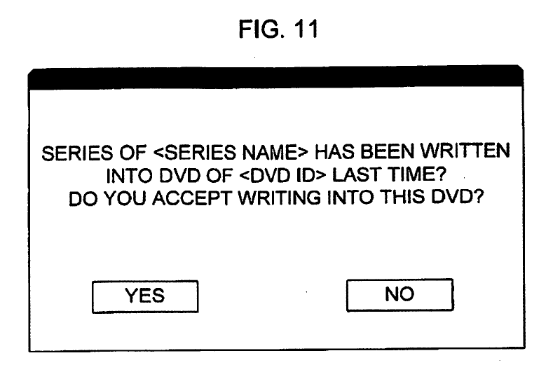

When they do not coincide with each other, the write-in control device 7 causes the UI 8 to display a warning 1 as exemplified in FIG. 11 as an investigation result, thereby to urge the user to determine propriety with regard to the write of the recorded digital broadcast program into the DVD currently inserted into the DVD drive 9 (step S15). When the user having viewed the warning 1 selects “yes” and, for example, clicks it with a mouse, the process of the step S6 and steps after it in FIG. 5 is executed.

When the user having viewed the warning 1 selects “No” and, for example, clicks it with a mouse, the write-in control device 7 causes the UI 8 to display the request 2 exemplified in FIG. 7, and the process of the step S7 and steps after it in FIG. 5 is executed.

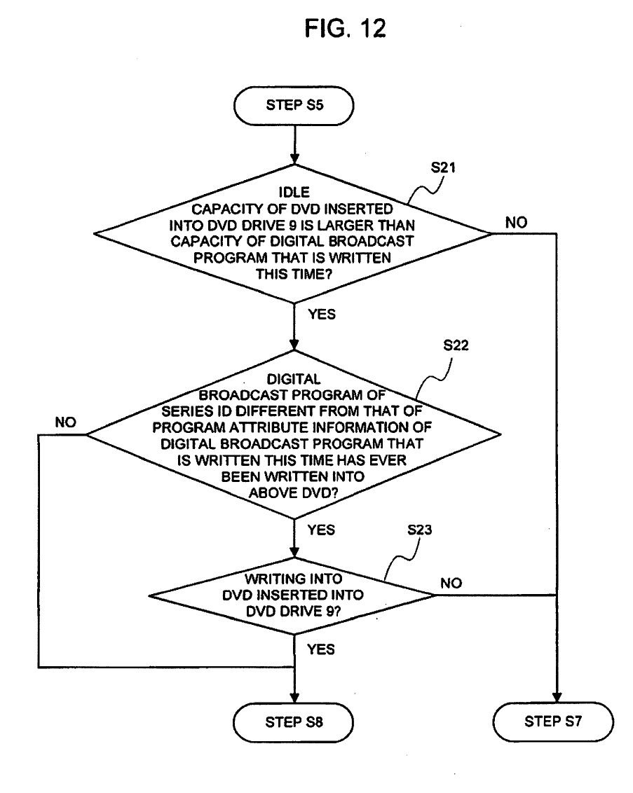

In addition hereto, the investigating process by the write-in control device 7 in the step S6 of FIG. 5 will be explained in details by making a reference to a flowchart of FIG. 12.

At first, the write-in control device 7 investigates which, out of the idle capacity of the DVD inserted into the DVD drive 9 and the capacity of the recorded digital broadcast program that is going to be written this time, is larger (step S21). When the capacity of the recorded digital broadcast program is larger than the idle capacity of the above DVD, the write-in control device 7 causes the UI 8 to display the request 3 exemplified in FIG. 8, and the process of the step S7 and steps after it in FIG. 5 is executed.

When the capacity of the recorded digital broadcast program that is going to be written this time is smaller than the idle capacity of the above DVD, or their capacities coincide with each other, the write-in control device 7 investigates whether the recorded digital broadcast program having a series ID different from that of the program attribute information of the recorded digital broadcast program that is going to be written this time has been ever written into the above DVD (step S22). If it has not been written, the process of the step S8 and steps after it in FIG. 5 is executed.

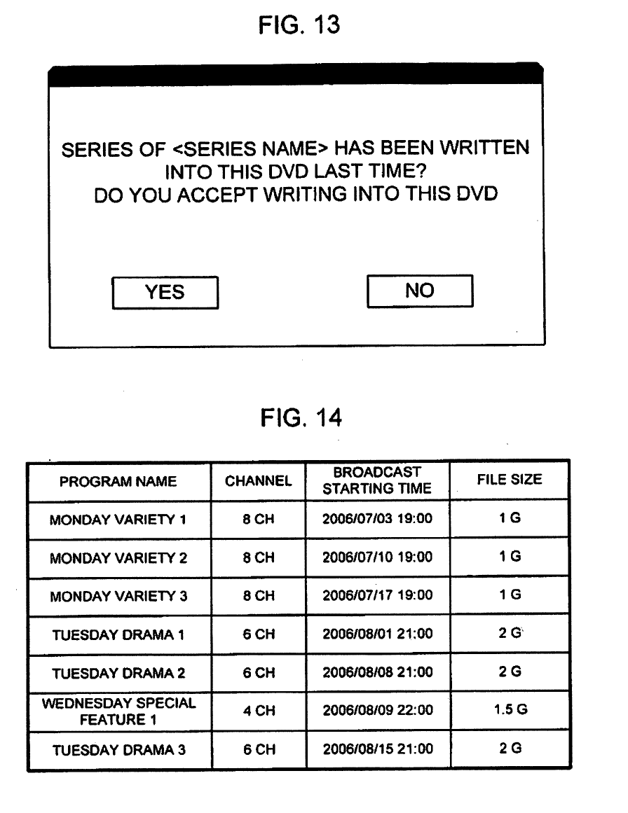

If it has been ever written, the write-in control device 7 causes the UI 8 to display a warning 2 as exemplified in FIG. 13 as an investigation result, thereby to urge the user to determine propriety with regard to the write of the recorded digital broadcast program into the DVD currently inserted into the DVD drive 9 (step S23). When the user having viewed the warning 2 selects “yes” and, for example, clicks it with a mouse, the process of the step S8 and steps after it in FIG. 5 is executed.

When the user having viewed the warning 2 selects “No” and, for example, clicks it with a mouse, the write-in control device 7 causes the UI 8 to display the request 4 exemplified in FIG. 9, and the process of the step S7 and steps after it in FIG. 5 is executed.

As explained above, in accordance with this embodiment, at the moment of writing the recorded digital broadcast program into a DVD, by confirming whether the recorded digital broadcast program previously written into the above DVD is a continuous digital broadcast program of a series identical to that of the recorded digital broadcast program that is going to be written, and notifying a confirmation result to the user, the continuous digital broadcast program of an identical series can be successively written into the identical DVD, and the continuous digital broadcast program classified into separate series can be written into the DVD.

Additionally, while it is determined whether or not the content of an identical series has been written in the past based upon the series ID in the foregoing, the information for determination is not limited hereto, and other information such as a series name, which makes it possible to determine whether or not the content belongs to an identical series, may be employed.

Next, the second embodiment of the present invention will be explained. Additionally, an identical numerical number is affixed to a component similar to that of the above-mentioned embodiment, and its explanation is omitted.

While the first embodiment premises that information associated with the series is contained in the EIT of the digital broadcast program, the reception device 3 determines the series by employing the method that is explained below in the second embodiment in the case of an analogue broadcast program, in the case that information associated with the series is not contained in the EIT even if the program is a digital broadcast program, and in the case that information associated with the series cannot be received.

In the second embodiment, the reception device 3 shown in FIG. 2 is a device for receiving a broadcast and an EPG (Electronic Program Guide) through the antenna 2, and generating program attribute information based upon a program name, a channel, and a broadcast starting time contained in the EPG. The program attribute information being generated herein is one shown in FIG. 14. And, while the write-in control device 7 shown in FIG. 2, when the program attribute information contained an identical series ID, determined that respective digital broadcast programs belonged to an identical series in the first embodiment, the write-in control device 7 determines that respective broadcast programs belong to an identical series in the second embodiment when the name of the broadcast program contains an identical character-string, the channel of the program is identical, and yet a lag of the broadcast starting time is, for example, one hour or less.

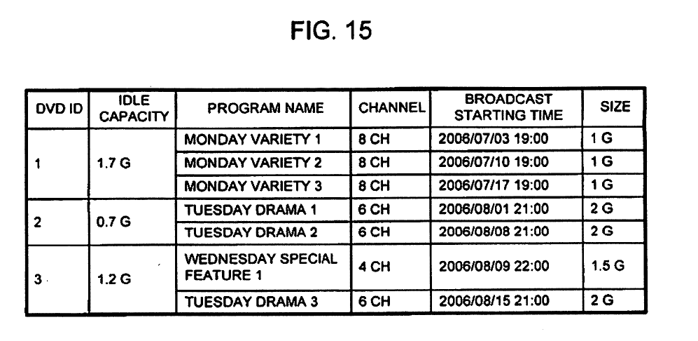

Additionally, the other processes are identical to that of the first embodiment. In addition, one example of information being recorded in the write-into-DVD history information storage region 6 is shown in FIG. 15.

As explained above, this embodiment makes it possible to obtain an effect similar to that of the first embodiment by generating the program attribute information, thereby to employ the above program attribute information for determining the series even though information associated the series of the broadcast program cannot be received.

Additionally, while the digital broadcast program and the analogue broadcast program were exemplified as a continuous content for explanation in the two embodiment mentioned above, not only the stationary-picture content and moving-picture content being prepared by a user, but also the content being streaming-distributed like a cable television, which is continuous, are acceptable. Further, while the DVD was exemplified as a storage medium into which the content was written, a hard disc drive or a flash memory may be employed so long as it is detachable, and loadable by other devices.

In addition hereto, while it was determined whether or not the content of an identical series was written in the past based upon the series ID in the foregoing, the information for determination is not limited hereto, and other information such as a series name, which makes it possible to determine whether or not the content belongs to an identical series, may be employed.

Further, as seen from the above-mentioned explanation, it is also possible to configure the foregoing write-in control device 7 with hardware, and it also can be realized with a computer program. In such a configuration, a processor that operates under a program stored into a program memory allows a function and operation similar to that of the foregoing embodiment to be realized.

As described above, employing the present invention makes it possible to consecutively write the continuous content of an identical series into an identical storage medium, and to write the continuous content classified into separate series into an identical storage medium. That is, employing the present invention makes it possible to select the content of an identical series from the storage region into which the content has been stored, and to record it into the identical storage medium.

This application is based upon and claims the benefit of priority from Japanese patent application No. 2006-265399, filed on Sep. 28, 2006, the disclosure of which is incorporated herein in its entirety by reference.

1. A write-in device, comprising:
an investigating means for investigating whether a first content already written into a storage medium and a second content that is going to be written into this storage medium belong to an identical series based upon information associated with each content; and
a writing-in means for writing said second content into said storage medium when as a result of said investigation, they belong to an identical series.

2. A write-in device according to claim 1, characterized in that:
said write-in device comprises:
a first storing means for storing identification information of said first content and identification information of said storage medium correspondingly to each other;
a second storing means for storing said second content; and
a third storing means for, when said second content has been stored in said second storing means, storing identification information of the above second content; and
said investigating means compares the identification information of said first content stored in said first storing means and the identification information of said second content stored in said third storing means, thereby to investigate whether they belong to an identical series, and when as a result of said investigation, they belong to an identical series, said writing-in means writes the second content stored in the second storing means into said storage medium.

3. A write-in device according to claim 1, characterized in that said investigating means investigates whether the first content already written into the storage medium and the second content that is going to be written into this storage medium belong to an identical series based upon program information indicating a text of said second content, write-in history information in which program information indicating a text of the content written into a storage medium in the past by said writing-in means and identification information for uniquely identifying the above storage medium are caused to correspond with each other, and identification information of the storage medium into which the second content is going to be written.

4. A write-in device according to claim 1, characterized in comprising a notifying means for notifying an investigation result to a user when as a result of said investigation, they do not belong to an identical series.

5. A write-in device according to claim 1, characterized in comprising a receiving means for receiving content information associated with each content, and generating the identification information or the program information of the first content and the second content from said content information.

6. A write-in device according to claim 5, characterized in that said content information is an event information table.

7. A write-in device according to claim 5, characterized in that said content information is an electronic program guide.

8. A write-in device according to claim 1, characterized in that, when said writing-in means has written said second content into a storage medium, said investigating means writes the program information of the above content and the identification information of the above storage medium correspondingly to each other into the write-in history information.

9. A write-in method, comprising:
an investigating step of investigating whether a first content already written into a storage medium and a second content that is going to be written into this storage medium belong to an identical series based upon information associated with each content; and
a second content writing-in step of writing said second content into said storage medium when as a result of said investigation, they belong to an identical series.

10. A write-in method according to claim 9, characterized in that:
said write-in method comprises:
a first content writing-in step of writing said first content into said storage medium;
a first storing step of storing identification information of said first content and identification information of said storage medium correspondingly to each other;
a second storing step of storing said second content; and
a third storing step of storing identification information of said stored second content;
said investigating step is a step of comparing the identification information of said first content stored in said first storing step and the identification information of said second content stored in said third storing step, thereby to investigate whether they belong to an identical series; and
said second content writing-in step is a step of writing the second content stored in the second storing step into said storage medium when as a result of said investigation, they belong to an identical series.

11. A write-in method according to claim 9, characterized in that said investigating step is a step of investigating whether the first content already written into the storage medium and the second content that is going to be written into this storage medium belong to an identical series based upon program information indicating a text of said second content, write-in history information in which program information indicating a text of the content written into a storage medium in the past and identification information for uniquely identifying the above storage medium are caused to correspond with each other, and identification information of the storage medium into which the second content is going to be written.

12. A write-in method according to claim 9, characterized in comprising a notifying step of notifying an investigation result to a user when as a result of said investigation, they do not belong to an identical series.

13. A write-in method according to claim 9, characterized in comprising:
a receiving step of receiving content information associated with each said content; and
a generating step of generating the identification information or the program information of the first content and the second content from said content information.

14. A write-in method according to claim 13, characterized in that said receiving step is a step of receiving an event information table as content information.

15. A write-in method according to claim 13, characterized in that said receiving step is a step of receiving an electronic program guide as content information.

16. A write-in method according to claim 9, characterized in that said investigation step is a step of, when said second content has been written into a storage medium, writing program information of the above content and identification information of the above storage medium correspondingly to each other into the write-in history information.

17. A computer readable record medium storing a program of an information processing device, characterized in causing said information processing device to execute:
an investigating step of investigating whether a first content already written into a storage medium and a second content that is going to be written into this storage medium belong to an identical series based upon information associated with each content; and
a second content writing-in step of writing said second content into said storage medium when as a result of said investigation, they belong to an identical series.
